(19) United States
(12) Patent Application Publication
(10) Pub. No.: US 2026/0247082 A1
(43) Pub. Date: Aug. 20, 2026

(54) MEMORY-EFFICIENT SINE SWEEP MEASUREMENT SYSTEM

(71) Applicant: Starkey Laboratories, Inc., Eden Prairie, MN (US)

(72) Inventors: Piero Iared Rivera Benois, Bad Zwischenahn (DE); Henning Schepker, Wardenburg (DE); Xianhua Jiang, Eden Prairie, MN (US)

(21) Appl. No.: 19/538,531

(22) Filed: Feb. 12, 2026

Related U.S. Application Data
(60) Provisional application No. 63/758,574, filed on Feb. 14, 2025.

(51) Int. Cl. H04R 25/00

(52) U.S. Cl. CPC H04R 25/305; H04R 25/505

(57) ABSTRACT

Memory-efficient sine sweep measurements enable improved acoustic characterization in hearing assistance devices and other audio systems. A digital signal processor (DSP) generates sine sweep stimulus signals on a sample-by-sample basis using recursive calculations and existing lookup tables, reducing or eliminating the need to store complete signal vectors. The sine sweep system implements correlation-based deconvolution through parallel processing paths that maintain separate impulse response calculations while sharing a common inverse stimulus. A first-in-first-out (FIFO) buffer system manages sample storage and updates, while recursive equations calculate impulse responses without requiring additional memory allocation. The sine sweep approach supports both single-channel and multi-channel measurements, enabling simultaneous characterization of linear and non-linear system components through controlled signal delays. This sine sweep method reduces memory requirements and peak power consumption by orders of magnitude compared to conventional approaches, making it suitable for implementation in devices with limited memory and processing resources.

### CROSS-REFERENCE TO RELATED APPLICATIONS

This application claims priority to U.S. Provisional Pat. Appl. No. 63/758,574, titled “MEMORY-EFFICIENT SINE SWEEP MEASUREMENT SYSTEM,” filed Feb. 14, 2025, which is hereby incorporated by reference herein in its entirety.

### TECHNICAL FIELD

Embodiments described herein generally relate to efficient sine sweep measurements in hearing assistance devices for acoustic characterization and system calibration.

### BACKGROUND

Existing hearing assistance devices, including hearing aids, amplify sound to enable audibility for individuals with hearing loss. These devices may be configured with amplification limits, which may constrain their ability to enhance sound levels. Such constraints arise from technical challenges associated with increasing gain, including acoustic leakage from the receiver to the microphone. This leakage may result in feedback, which may interfere with the functionality of the device.

Hearing assistance devices may rely on acoustic characterization and calibration to provide optimal performance. Acoustic characterization involves analyzing the acoustic properties of the device, including frequency response, amplification characteristics, and signal distortion, under various conditions. Calibration aligns the device output with the intended performance parameters to address the specific hearing profile of a user. Inaccurate characterization or calibration can lead to suboptimal hearing assistance performance, which may result in user discomfort, diminished auditory clarity, or feedback issues.

It is desirable to provide improved acoustic characterization and calibration for hearing aids and other audio amplification devices.

### BRIEF DESCRIPTION OF THE DRAWINGS

FIG. 1 is a functional block diagram of a sine sweep measurement procedure.

FIG. 2 is a functional block diagram of a sine sweep measurement system, in accordance with at least one embodiment of the invention.

FIG. 3 is a functional block diagram of a multi-channel linear measurement system, in accordance with at least one embodiment of the invention.

FIG. 4 is a functional block diagram of a single-channel linear and nonlinear measurement system, in accordance with at least one embodiment of the invention.

FIG. 5 is a functional block diagram of an alternative single-channel measurement system, in accordance with at least one embodiment of the invention.

FIG. 6 is a method for performing acoustic characterization using sine sweep measurements on a digital signal processor, in accordance with at least one embodiment of the invention.

FIG. 7 illustrates a block diagram of an example machine upon which any one or more of the techniques (e.g., methodologies) discussed herein may perform.

### DESCRIPTION OF EMBODIMENTS

The subject matter described herein provides technical solutions to address technical problems facing acoustic characterization and calibration. In particular, this subject matter provides improved measurement of impulse responses used to characterize acoustical systems. The sine sweep measurement provides improved measurement of impulse responses by separating the linear behavior of the acoustical system from nonlinear behavior of the acoustical system, then providing interleaving and overlapping sine sweep strategies that provide simultaneous measurement of all impulse responses of a multi-channel system.

The sine sweep measurement includes a calculation of the impulse response by a deconvolution process. This deconvolution process may include a direct calculation approach. The direct-calculation implementation of the deconvolution process may include a memory allocation of approximately Rₘ≅4. Lₓ samples, where Lₓ is the length of the measurement stimulus measured in samples. Additionally, the deconvolution process may include an approximate total of

$${R}_{c}^{t otal} ≅ {L}_{x}^{2}$$

multiply-add calculations. The energy consumption of the deconvolution process is proportional to the squared length of the measurement stimulus. When increased throughput is desired, the deconvolution process may be performed concurrently with the measurement and a peak of

$${R}_{c}^{p e a k} = {L}_{x}$$

multiply-add calculations are performed in a single sample period. The peak multiply-add calculations performed by the deconvolution process are approximately proportional to the peak power consumption, i.e.,

$${R}_{c}^{peak} ∝ {R}_{P}^{peak}$$

of the measurement. The improved sine sweep solutions described herein provide improvements by reducing processing and memory resources used in sine sweep measurements. In some examples, these improved sine sweep solutions decrease by orders of magnitude the total multiplications and memory used in sine sweep measurement methods.

The improved sine sweep solutions described herein provide improved single- and multi-channel sine sweep measurements for digital signal processors (DSPs) that are subject to low-power consumption and low-memory constraints. This is particularly beneficial for DSPs used in portable electronic devices, such as the DSPs used in hearing aids. These solutions further provide improved measurement throughput for DSPs used for the calibration of multi-channel sound systems, for measurement of head-related transfer functions, or for other audio systems.

These improved sine sweep solutions provide advantages over alternative sine sweep solutions, such as those that use a series of iterative steps that progressively converge toward the desired value. One example of an alternative sine sweep solutions includes a Coordinate Rotation Digital Computer (CORDIC) algorithm, which functions as an oscillator whose cutoff frequencies change exponentially over time to generate the stimulus signal. The present solutions provide reduced computational and memory requirements over the CORDIC algorithm and similar solutions that re-calculate signals for each sample in the impulse response. In particular, the present solutions generate the stimulus signal on a sample-by-sample basis using a straightforward recursive approach with lookup tables for sine wave calculation, which reduces or eliminates the need to store complete signal vectors and dramatically reduces memory requirements. Additionally, the present solutions implement a selective sample-by-sample deconvolution process that calculates only the coefficients needed for the desired impulse response length, thereby reducing or minimizing computational resources compared to approaches that calculate the complete impulse response. This provides significant advantages over the CORDIC implementation and other alternative approaches, particularly for memory-constrained and low-power devices, reducing memory requirements by orders of magnitude while maintaining measurement accuracy.

This description of embodiments of the present subject matter refers to subject matter in the accompanying drawings, which show, by way of illustration, specific aspects and embodiments in which the present subject matter may be practiced. These embodiments are described in sufficient detail to enable those skilled in the art to practice the present subject matter. References to “an,” “one,” or “various” embodiments in this disclosure are not necessarily to the same embodiment, and such references contemplate more than one embodiment. The above detailed description is demonstrative and not to be taken in a limiting sense. The scope of the present subject matter is defined by the appended claims, along with the full scope of legal equivalents to which such claims are entitled.

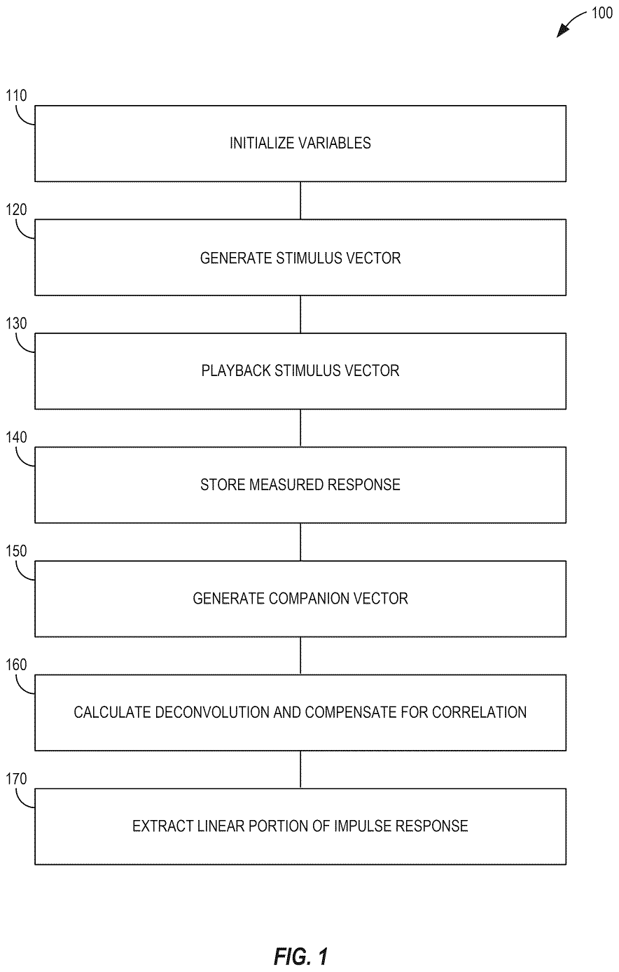

FIG. 1 is a functional block diagram of a sine sweep measurement procedure 100. The sine sweep measurement procedure 100 provides a direct calculation and storage approach. This approach calculates a measurement stimulus x(n) and companion time-series xᵢₙᵥ(n), then stores them together with the measured signal y(n) and complete impulse response h(n).

At 110, sine sweep measurement procedure 100 includes initializing the stimulus amplitude A, start angular frequency Ωₛₜₐᵣₜ, end angular frequency Ω_{end}, and stimulus length in samples given by the rule Lₓ=fₛ·Tₛₜᵢₘᵤₗᵤₛ, where fₛ is the sampling frequency and T is the stimulus duration measured in seconds. At 120, sine sweep measurement procedure 100 includes generating stimulus vector:

$$x ( n ) = A \cdot sin ( \frac{{Ω}_{start} \cdot ( {L}_{x} - 1 )}{ln \frac{{Ω}_{end}}{{Ω}_{start}}} \cdot ( {e}^{\frac{n}{{L}_{x} - 1} ln \frac{{Ω}_{end}}{{Ω}_{start}}} - 1 ) ) ,$$

At 130, sine sweep measurement procedure 100 includes playing back the stimulus vector x(n). At 140, sine sweep measurement procedure 100 includes storing the measured response y(n). At 150, sine sweep measurement procedure 100 includes generating companion vector

$${x}_{i n v} ( n ) = {A}_{i n v} ( n ) \cdot x ( {L}_{x} - 1 - n ) ,$$

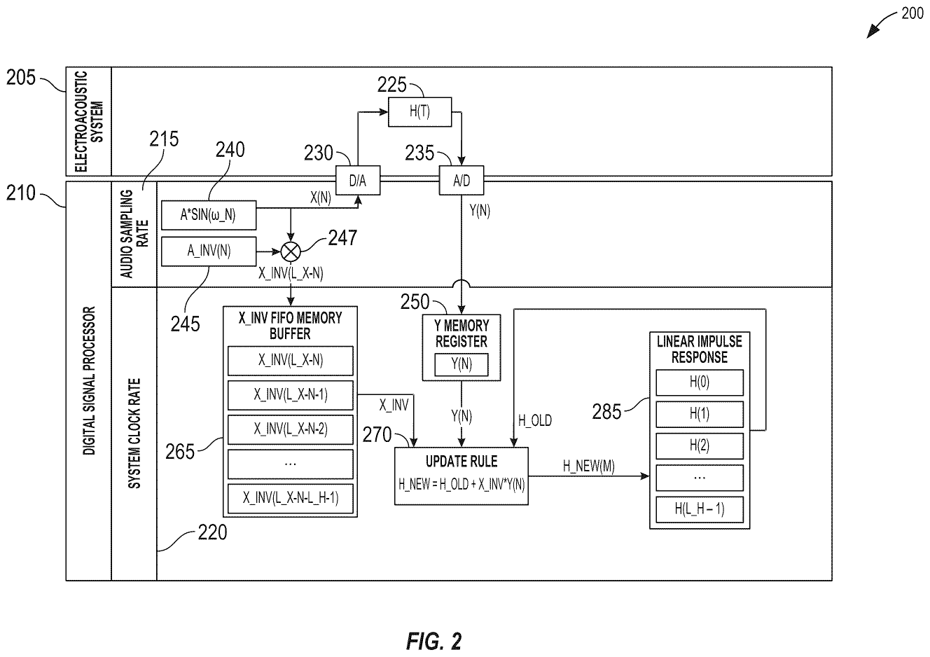

The inverse amplitude value Aᵢₙᵥ(n) is calculated by the following equation:

$${A}_{i n v} ( n ) = {A}_{i n v} ( n - 1 ) \cdot {α}^{- 1} ,$$

where Aᵢₙᵥ(0)=A/C, and C is the correlation factor between xᵢₙᵥ(n) and x(n), given by the following equation:

$$C = \frac{{A}^{2} {L}_{x} ( \frac{{f}_{start}}{{f}_{end}} - 1 )}{4 ( {f}_{end} - {f}_{start} ) \cdot ln ( \frac{{f}_{start}}{{f}_{end}} )} ,$$

where fₛₜₐᵣₜ and f_{end} are the start and end frequencies, respectively. The calculations of Aᵢₙᵥ(n) and C are discussed further below with respect to the sine sweep measurement system 200 shown in FIG. 2.

At 160, sine sweep measurement procedure 100 includes calculating deconvolution and compensating for correlation:

$$\hat{h} ( n ) = y ( n ) * {x}_{i n v} ( n ) / C .$$

At 170, sine sweep measurement procedure 100 includes extracting the linear portion of the impulse response:

$${\hat{h}}_{lin} ( n ) = {\{ \hat{h} ( n ) \}}_{{L}_{x} , lin} .$$

A detailed implementation of the sine sweep measurement procedure 100 is shown and described with respect to the sine sweep measurement system 200 in FIG. 2.

FIG. 2 is a functional block diagram of a sine sweep measurement system 200, in accordance with at least one embodiment of the invention. The sine sweep measurement system 200 shows an implementation of the present solutions that focuses on the measurement of only the linear component of the impulse response. The sine sweep measurement system 200 includes an electroacoustic system 205 and a DSP 210. The DSP 210 processes samples at an audio sampling rate 215 (e.g., 40 kHz). The audio sampling rate 215 may determine the timing of sample generation and acquisition from the electroacoustic system 205. The DSP 210 also processes computational operations between audio samples at a system clock rate 220, where the system clock rate 220 is higher than the audio sampling rate 215. The system clock rate 220 may be used in execution of multiply-add calculations, impulse response value updates, and memory buffer operations. In an example, the system clock rate 220 may be five hundred times greater (e.g., 20 MHz) than the audio sampling rate 215, which supports the recursive calculation approach and reduces or eliminates a need for complete signal vector storage.

To avoid the storage of the measurement stimulus x(n), the sine sweep measurement system 200 uses a recursive approach to sample by sample calculate x(n) without storing more than the current sample for the measurement to operate. Instead of using an oscillator to generate the exponential sine sweep, the sine sweep measurement system 200 uses a sine function instead, which argument is recalculated every sample time by setting fᵤₚ(0)=fₛₜₐᵣₜ and applying the following recursion rules:

$${f}_{u p} ( n ) = α \cdot {f}_{u p} ( n - 1 ) ,$$

$${ω}_{n} = {ω}_{n - 1} + 2 π \frac{{f}_{u p}}{{f}_{s}} ,$$

$$and$$

$$x ( n ) = A ⋅ sin ( {ω}_{n} ) ,$$

where A is the desired amplitude and

$$α = {( \frac{{f}_{e n d}}{{f}_{start}} )}^{\frac{1}{{L}_{x} - 1}}$$

is a fixed parameter calculated during initialization after choosing the start frequency fₛₜₐᵣₜ, the end frequency f_{end}, and stimulus length Lₓ.

After each cycle of these recursions generated by sine sampler 240, the resulting sample of x(n) is digital-to-analog (D/A) converted at D/A converter 230 and provided to the acoustic system h(t) 225. The output signal y(n) of the acoustic system h(t) 225 is analog-to-digital (A/D) converted at A/D converter 235 and provided to Y-memory register 250.

The sine sweep measurement system 200 provides improvements over oscillator-based solutions. These oscillator-based solutions may run an oscillator in inverse modus (e.g., from to f_{end} to fₛₜₐᵣₜ) to generate a companion time-series xᵢₙᵥ(n). With the companion time-series xᵢₙᵥ(n), the oscillator-based solutions calculate the impulse response of the acoustic system through a deconvolution process given by

$$\hat{h} ( n ) = {x}_{i n v} ( n ) * y ( n ) ,$$

where * denotes the convolution operand.

In contrast with those oscillator-based solutions that perform recalculations for each sample in ĥ(n), the sine sweep measurement system 200 avoids the computationally intensive (e.g., computationally expensive) recalculation of xᵢₙᵥ(n) by buffering in memory only the samples of xᵢₙᵥ(n) needed for the sample-by-sample deconvolution. The sine sweep measurement system 200 also provides reduced power consumption by reformulating the deconvolution as an equivalent correlation calculation, where the companion time-series xᵢₙᵥ(n) is time-reversed:

$$\hat{h} ( τ ) = {x}_{i n v} ( {L}_{x} - n ) ⋆ y ( n ) .$$

The time-reversed xᵢₙᵥ(Lₓ−n) can be directly generated based on x(n) by the following equation:

$${x}_{i n v} ( {L}_{x} - n ) = {A}_{i n v} ( n ) \cdot x ( n ) ,$$

which is implemented at multiplier 247. The inverse amplitude value Aᵢₙᵥ(n) is calculated at inverse amplitude block 245 by the following equation:

$${A}_{i n v} ( n ) = {A}_{i n v} ( n - 1 ) \cdot {α}^{- 1} ,$$

where Aᵢₙᵥ(0)=A/C, and C is the correlation factor between xᵢₙᵥ(n) and x(n), given by the following equation:

$$c = \frac{{A}^{2} {L}_{x} ( \frac{{f}_{start}}{{f}_{e n d}} - 1 )}{4 ( {f}_{e n d} - {f}_{start} ) \cdot ln ( \frac{{f}_{start}}{{f}_{e n d}} )} .$$

The sine sweep measurement system 200 generates both x(n) and Xᵢₙᵥ(Lₓ−n) using one signal generator simultaneously. Furthermore, the sine sweep measurement system 200 avoids the need for recalculations of Xᵢₙᵥ(Lₓ−n) during the deconvolution process by buffering in memory only the samples of xᵢₙᵥ(n) needed for the sample-by-sample deconvolution.

The time-reversed xᵢₙᵥ(Lₓ−n) is provided to a first-in-first-out (FIFO) memory buffer, such as to inverse amplitude FIFO memory buffer 265. The inverse amplitude FIFO memory buffer 265 provides the buffered values in xᵢₙᵥ to be combined with y(n) from y-memory register 250 at update rule block 270.

The cross-correlation is given by the following sum:

$$\hat{h} ( τ ) = {\sum }_{n} {x}_{i n v} ( {L}_{x} - n ) \cdot y ( n + τ ) ,$$

which sums over the multiplications between the current xᵢₙᵥ(Lₓ−n) sample and future samples of y(n+τ). To reduce or eliminate the need for future samples y(n), the sine sweep measurement system 200 implements an alternative formulation as follows:

$$\hat{h} ( τ ) = {\sum }_{n} {x}_{i n v} ( {L}_{x} - n - τ ) \cdot y ( n ) ,$$

Instead of using future samples y(n), this alternative formulation applies the storage of past samples of xᵢₙᵥ(Lₓ−n) and their multiplication with the current sample of the output signal y(n). To reduce or minimize the peak and total amount of multiply-add operations used by the deconvolution process, the subset of τ that leads to desired Lₕ coefficients of the impulse response of the acoustic system h(t), \hat{τ}∈{0, Lₕ−1}, is calculated as follows:

$${h}_{l i n} = h ( \hat{τ} ) = {\sum }_{n} {x}_{i n v} ( {L}_{x} - n - \hat{τ} ) \cdot y ( n ) .$$

A time delay for xᵢₙᵥ(Lₓ−n) or y(n) determines the relative position of those Lₕ samples inside the “complete” impulse response. The previous equation can be implemented in update rule block 270 as a recursive least squares equation without a forgetting factor that follows the update equation:

$${\vec{h}}_{lin} = {\vec{h}}_{lin} + {\vec{x}}_{i n v} \cdot y ( n ) .$$

As shown in update rule block 270, this corresponds to the following:

$${H}_{n e w} = {H}_{o l d} + {x}_{i n v} \cdot y ( n ) .$$

Each value of H_{new} is then provided to linear impulse response block 285. The impulse response block 285 stores and updates the coefficients that characterize the linear acoustic behavior of the system. The output of the impulse response block 285 H_{old} is provided back to the update rule block 270, where H_{old} is used to calculate H_{new} based on the equation above.

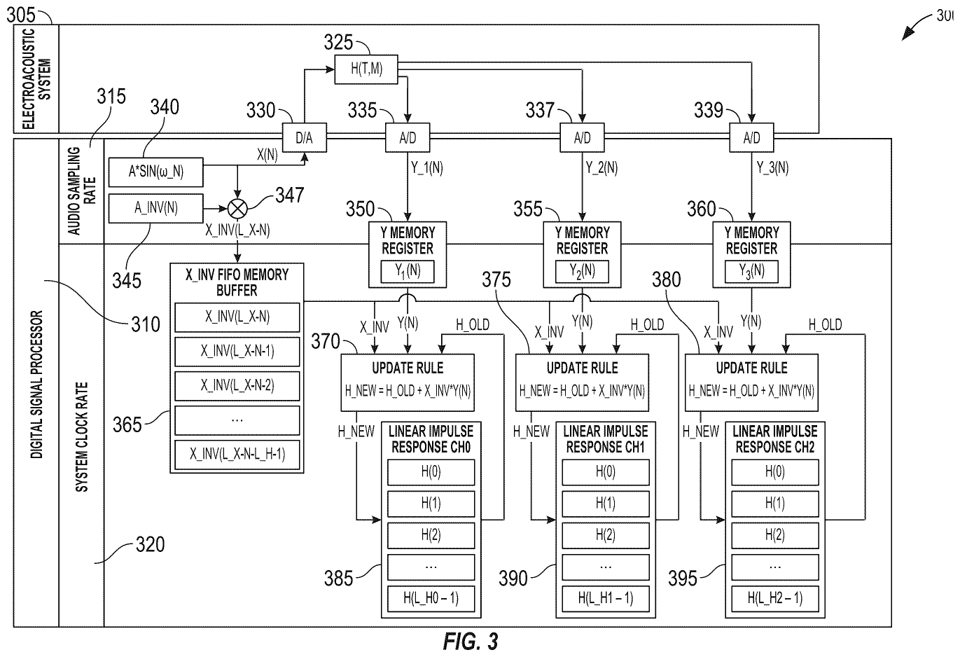

FIG. 3 is a functional block diagram of a multi-channel linear measurement system 300, in accordance with at least one embodiment of the invention. The multi-channel linear measurement system 300 is similar to sine sweep measurement system 200, but is extended to analyze the linear impulse response of several microphone channels. The multi-channel linear measurement system 300 includes an electroacoustic system 305 and a digital signal processor 310. The multi-channel linear measurement system 300 processes samples at an audio sampling rate 315 and performs computational operations at a system clock rate 320.

A sine sampler 340 generates samples of x(n), and the electroacoustic system 305 receives input samples of x(n) through a D/A converter 325 and provides output through multiple A/D converters 335, 337, and 339 and to separate Y-memory registers 350, 355, and 360. Each of the multiple A/D converters 335, 337, and 339 and separate Y-memory registers 350, 355, and 360 corresponds to a separate microphone channel.

An inverse amplitude value Aᵢₙᵥ(n) is calculated at inverse amplitude block 345, and the time-reversed xᵢₙᵥ(Lₓ−n) is generated based on x(n) at multiplier 347. The time-reversed xᵢₙᵥ(Lₓ−n) is provided to inverse amplitude FIFO memory buffer 365. The inverse amplitude FIFO memory buffer 365 provides the buffered values in xᵢₙᵥ to be combined with y(n) from each of the Y-memory registers 350, 355, and 360 at respective update rule blocks 370, 375, and 380. For a device with multiple microphones, the inverse amplitude FIFO memory buffer 365 may provide the same [symbol] used for the multiplication with the current sample of the first microphone y₁(n) and the signal of the additional microphones y₂(n) y₃(n) . . . y_{M}(n) from each of the Y-memory registers 350, 355, and 360 at respective update rule blocks 370.

Each of the update rule blocks 370, 375, and 380 implements the recursive least squares equation without a forgetting factor as H_{new}=H_{old}+Xᵢₙᵥ·y(n). Each respective value of H_{new} is then provided to respective linear impulse response blocks 385, 390, and 395. The linear impulse response blocks 385, 390, and 395 calculate the impulse responses in parallel but accumulated in different vectors [symbol] , [symbol] , [symbol] . . . [symbol] . The linear impulse response blocks 385, 390, and 395 provide a respective H_{old} back to corresponding update rule blocks 370, 375, and 380, where H_{old} is again used to calculate H_{new} based on the equation above.

When multi-channel linear measurement system 300 is used to characterize a device with multiple receivers, interleaving and overlapping strategies would be used to reduce or minimize the measurement time. When the measurement time does not need to be minimized, the stimulus may be played back through one receiver at a time, and the impulse responses stored before continuing with the next receiver.

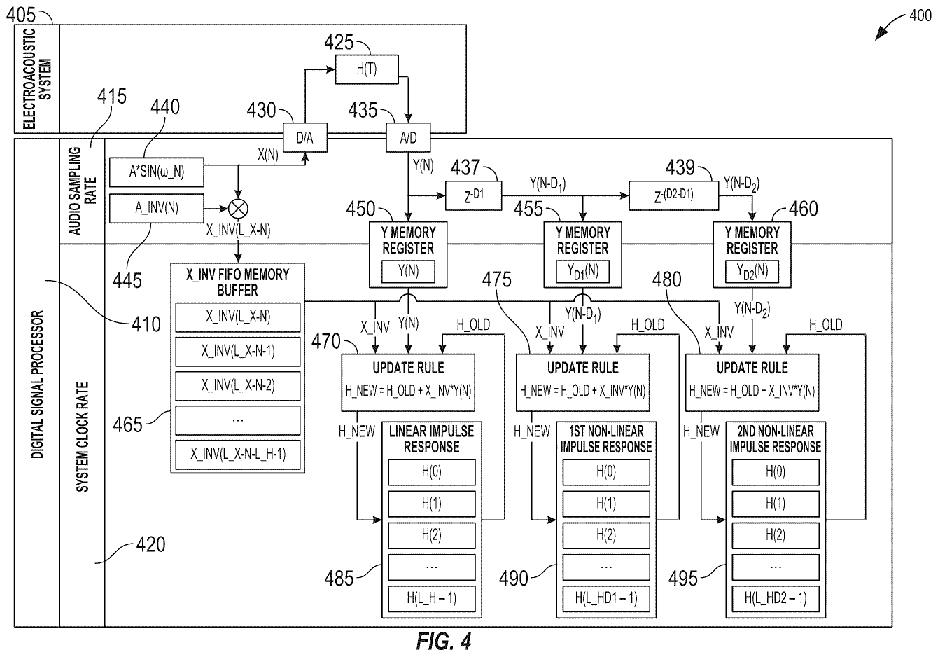

FIG. 4 is a functional block diagram of a single-channel measurement system 400, in accordance with at least one embodiment of the invention. The single-channel measurement system 400 may be used to measure linear and non-linear components of the impulse response. The single-channel measurement system 400 is similar to multi-channel linear measurement system 300, but instead of analyzing linear components of multiple channels, the single-channel measurement system 400 is extended to analyze both the linear and nonlinear components of the impulse response.

The single-channel measurement system 400 includes an electroacoustic system 405 and a digital signal processor 410. The single-channel measurement system 400 processes samples at an audio sampling rate 415 and performs computational operations at a system clock rate 420.

A sine sampler 440 generates samples of x(n), and the electroacoustic system 405 receives input samples of x(n) through a D/A converter 430 and provides an output y(n) through A/D converter 435. The single-channel measurement system 400 implements first delay block Z^{-D1} 437 and second delay block Z^{-(D2-D1)} 439 to introduce specific delays in the measured response signal y(n), enabling measurement of nonlinear components. In each of the first delay block Z^{-D1} 437 and second delay block Z^{-(D2-D1)} 439, the measured signal y(n) is delayed by a number of samples given by the following equation:

$${D}_{d} = ceil ( log ( d ) \cdot {f}_{S} \cdot T / log ( \frac{{ω}_{e n d}}{{ω}_{start}} ) )$$

where d is the order of the distortion component, fₛ is the sampling frequency, T is the duration of the sine sweep in seconds, and ω_{end} and ωₛₜₐᵣₜ are the already-known start and end angular frequencies.

The non-delayed signal y(n) is provided from y-memory register 450 to update rule block 470. Similarly, the first delayed signal y^{n-D1} is provided from first delay Y-memory register 455 to first delay rule block 475, and the second delayed signal y^{(n-D2)} is provided from second delay Y-memory register 460 to second delay rule block 480.

An inverse amplitude value Aᵢₙᵥ(n) is calculated at inverse amplitude block 445, a time-reversed xᵢₙᵥ(Lₓ−n) is generated at multiplier 447, and the time-reversed xᵢₙᵥ(Lₓ−n) is provided to inverse amplitude FIFO memory buffer 465. The inverse amplitude FIFO memory buffer 465 provides the buffered values in xᵢₙᵥ to each of the update rule blocks 470, 475, and 480.

The single-channel measurement system 400 maintains three parallel processing paths, each implementing the recursive update rule H_{new}=H_{old}+Xᵢₙᵥ· y(n). Each respective value of H_{new} is then provided to respective impulse response blocks 485, 490, and 495. The single-channel measurement system 400 generates three distinct impulse responses: a linear impulse response 485, a first nonlinear impulse response 490, and a second nonlinear impulse response 495. The impulse response blocks 485, 490, and 495 provide a respective H_{old} back to corresponding update rule blocks 470, 475, and 480, where H_{old} is again used to calculate H_{new}. The single-channel measurement system 400 provides simultaneous measurement of both linear and nonlinear components of the system response while maintaining efficient memory usage through the recursive calculation approach.

The sine sweep solutions described herein provide reduced memory and calculation requirements compared to alternative solutions. Table 1 shows a comparison of the approximated memory and calculation requirements of the deconvolution process using an alternative direct calculation approach, an alternative oscillator approach (e.g., CORDIC algorithm), and the improved sine sweep solutions:

TABLE 1

| | | Total Calculations | Peak Calculations |
|---|---|---|---|
| Approach | Memory Used (Rₘ) | $( {R}_{c}^{t otal} )$ | $( {R}_{c}^{peak} )$ |
| Direct Calculation | 4Lₓ | ${L}_{x}^{2}$ | Lₓ |
| Oscillator | Lₓ | Lₕ · (Lₓ − Lₕ) + | Lₓ^{(*)} |
| | | ${L}_{h}^{2} / {2}^{\text{(*} )}$ | |
| Improved | 2Lₕ | Lₕ · Lₓ | Lₕ |
| Sine Sweep | | | |
| Solutions | | | |

(* The oscillator approach recalculates xᵢₙₜ for each sample in ĥ(τ)).

Table 2 shows a comparison of the approximated memory and calculation requirements for each of the three approaches based on a sampling frequency of fₛ=40 kHz, a measurement stimulus duration of dₛ=3 seconds, and an impulse response of 160 coefficients:

TABLE 2

| | | Total Calculations | Peak Calculations |
|---|---|---|---|
| Approach | Memory Used (Rₘ) | $( {R}_{c}^{t otal} )$ | $( {R}_{c}^{peak} )$ |
| Direct Calculation | 480,000 | 14,400,000,000 | 120,000 MAC |
| | samples | MAC | |
| Oscillator | 120,000 | 19,187,200 MAC | 120,000 MAC ^{(*)} |
| | samples | ^{(*)} | |
| Improved Sine | 320 samples | 19,200,000 MAC | 160 MAC |
| Sweep Solutions | | | |
| Ratio of Direct to | 1500 | 750 | 750 |
| Sine Sweep | | | |
| Ratio of Oscillator | 375 | 1 | 750 |
| to Sine Sweep | | | |

For the example shown in Table 2 above, the improved sine sweep solutions use 1500-times less memory, 750-times fewer calculations, and reaches a peak in calculations that is 750-times smaller than the direct calculation approach. Moreover, the improved sine sweep solutions also require 375-times less memory and reaches a peak of calculations that is 750-times smaller than the oscillator approach. Although the improved sine sweep solutions use the same number of total calculations in the deconvolution process, when compared to the oscillator approach, these estimations do not consider the additional computations used in the oscillator approach for re-calculating xᵢₙᵥ(n) for the calculation of each sample in ĥ (t). The improved sine sweep solutions provide substantial improvements in memory usage and processing over alternative solutions.

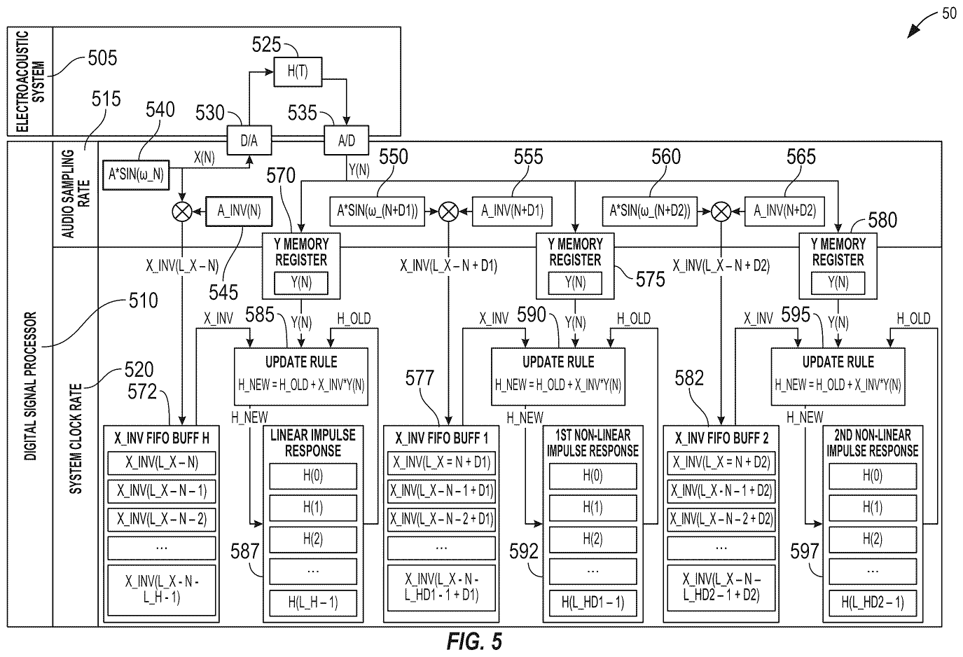

FIG. 5 is a functional block diagram of an alternative single-channel measurement system 500, in accordance with at least one embodiment of the invention. The alternative single-channel measurement system 500 may be used to measure linear and non-linear components of the impulse response. The alternative single-channel measurement system 500 provides a memory-efficient architecture that avoids the need for delay elements by using replicated signal generators for each processing channel. This architecture provides reduced memory requirements compared to delay-based approaches when the delay values exceed the combined lengths of the non-linear impulse responses being measured.

The alternative single-channel measurement system 500 uses additional computational resources compared to delay-based architectures due to the replicated signal generators. The first non-linear sine sampler 550, first non-linear inverse amplitude block 555, second non-linear sine sampler 560, and second non-linear inverse amplitude block 565 perform calculations that may not be required in a delay-based architecture. This trade-off between memory and computation allows selection of the appropriate architecture based on the constraints of the target device. For devices where memory is the binding constraint and computational resources are available, the alternative single-channel measurement system 500 provides reduced memory requirements. For devices where computational resources are the binding constraint and memory is available, the delay-based architecture of FIG. 4 may be selected.

The alternative single-channel measurement system 500 may be extended to measure additional non-linear components beyond the second-order and third-order distortion components shown. Additional signal generation paths may be added with corresponding sine samplers, inverse amplitude blocks, FIFO buffers, update rule blocks, and impulse response blocks for higher-order distortion components. The delay values for these additional components are calculated using the delay equation with an appropriate distortion order.

The alternative single-channel measurement system 500 supports selective measurement of specific non-linear component orders. An engineer may configure the system to measure odd-order distortion components (e.g., third-order, fifth-order), even-order distortion components (e.g., second-order, fourth-order), or arbitrary combinations based on the characteristics of the device under test. For example, if prior characterization indicates that even-order distortion is dominant, the system may be configured with signal generation paths for D2 and D4 corresponding to second-order and fourth-order distortion components. Sequential measurements with different delay configurations may be performed to capture higher-order components that exceed the number of parallel signal generation paths available.

The alternative single-channel measurement system 500 may be used to estimate a parameter K that characterizes the ratio between linear and non-linear impulse response energy. When configuring a multi-receiver system for interleaving and overlapping measurement strategies, the parameter K determines the spacing between delayed sine sweeps to prevent overlap of impulse response components from different receivers. The parameter K may be estimated a priori by sequentially measuring each receiver channel using the alternative single-channel measurement system 500 to determine the largest order of non-linearity present across all receiver-to-microphone transfer functions. Once the parameter K is determined for each receiver channel, the system may proceed with simultaneous multi-receiver measurements using appropriately spaced delayed sine sweeps.

When the alternative single-channel measurement system 500 is extended to a multi-receiver configuration with N receiver channels, interleaving and overlapping strategies may be applied to reduce measurement time. The procedure includes generating N delayed sine-sweep stimuli to be independently played back through the N receivers. The system deconvolves all N responses together using the correlation-based approach, generating a single impulse response of approximately N times the length of an individual impulse response (N×Lₕ). Individual impulse responses for each receiver-to-microphone transfer function are extracted from the combined impulse response by calculating starting and ending indices corresponding to each receiver channel. When measurement time reduction is not required, the stimulus may alternatively be played back through one receiver at a time, with each impulse response stored before proceeding to the next receiver.

The interleaving and overlapping techniques may also be applied to a single-receiver configuration to improve signal-to-noise ratio of the impulse response measurement. Using interleaving and overlapping with a single receiver, the same impulse response may be measured N times while requiring less than N times the measurement duration. The multiple impulse response measurements are averaged to obtain an improved signal-to-noise ratio. The system may continuously estimate the signal-to-noise ratio of the identified impulse response during measurement and terminate the measurement once a desired signal-to-noise ratio threshold is achieved. Alternatively, the measurement may continue until either the desired signal-to-noise ratio is achieved or a preset maximum measurement duration is reached to prevent excessive measurement time in noisy environments.

The alternative single-channel measurement system 500 includes an electroacoustic system 505 and a digital signal processor 510. The alternative single-channel measurement system 500 processes samples at an audio sampling rate 515 (e.g., 40 kHz) and performs computational operations at a system clock rate 520. The audio sampling rate 515 determines the timing of sample generation and acquisition from the electroacoustic system 505. The system clock rate of 520 is higher than the audio sampling rate of 515 and is used for multiply-add calculations, impulse response value updates, and memory buffer operations.

The electroacoustic system 505 includes an acoustic system 525 that represents the transfer function of the electroacoustic system being characterized. The digital signal processor 510 provides a stimulus signal x(n) to a D/A converter 530, which converts the digital stimulus to an analog signal for the acoustic system 525. The acoustic system 525 produces an output that is converted by an A/D converter 535 to generate the measured response signal y(n).

The alternative single-channel measurement system 500 implements three parallel signal generation paths to enable simultaneous measurement of linear and non-linear impulse response components without applying delay elements to the measured response signal. A linear sine sampler 540 generates samples of x(n) for linear impulse response measurement. The output of the linear sine sampler 540 is provided to the D/A converter 530 for playback through the electroacoustic system 505. A linear inverse amplitude block 545 generates an inverse amplitude value A_inv(n) for the linear channel. The output of the linear sine sampler 540 is multiplied by the output of the linear inverse amplitude block 545 to generate a time-reversed inverse stimulus for the linear channel, which is provided to the Xinv first-in-first-out (FIFO) buffer H 572. The time-reversed inverse stimulus Xᵢₙᵥ(Lₓ−n) may be derived from x(n) using the equation

$${X}_{inv} ( n ) = {A}_{inv} ( n ) \cdot x ( {L}_{x - 1 - n} ) ,$$

enabling simultaneous generation of both the stimulus and inverse stimulus from a single signal generator without requiring separate lookup tables or independent inverse-signal computation.

A first non-linear sine sampler 550 generates samples for first non-linear impulse response measurement based on delay D1, where delay D1 represents the delay corresponding to the second-order distortion component. The output of the first non-linear sine sampler 550 is multiplied by the output of the first non-linear inverse amplitude block 555 at a first non-linear multiplier and provided to Xᵢₙᵥ FIFO buffer 1 577. Similarly, a second non-linear sine sampler 560 generates samples for a second non-linear impulse response measurement based on delay D2, where delay D2 represents the delay corresponding to the third-order distortion component. The output of the second non-linear sine sampler 560 is multiplied by the output of the second non-linear inverse amplitude block 565 at a second non-linear multiplier and provided to Xᵢₙᵥ FIFO buffer 2 582.

The measured signal y(n) is delayed by a number of samples given by the following equation:

$${D}_{d} = ceil ( log ( d ) \cdot {f}_{S} \cdot T / log ( \frac{{ω}_{e n d}}{{ω}_{start}} ) )$$

where d is the order of the distortion component, fₛ is the sampling frequency, T is the duration of the sine sweep in seconds, and ω_{end} and ωₛₜₐᵣₜ are the already-known start and end angular frequencies.

The measured response signal from the A/D converter 535 is provided to three separate Y memory registers. A first memory register 570 stores the current measured sample for linear channel processing. Similarly, a second memory register 575 stores the current measured sample for first non-linear channel processing, and a third memory register 580 stores the current measured sample for second non-linear channel processing.

The time-reversed inverse stimulus from the linear channel is provided to Xᵢₙᵥ FIFO buffer H 572. The Xᵢₙᵥ FIFO buffer H 572 stores Xᵢₙᵥ samples for linear impulse response calculation. The time-reversed inverse stimulus from the first non-linear channel is provided to Xᵢₙᵥ FIFO buffer 1 577. The Xᵢₙᵥ FIFO buffer 1 stores Xᵢₙᵥ samples for first non-linear impulse response calculation. Similarly, the time-reversed inverse stimulus from the second non-linear channel is provided to Xᵢₙᵥ FIFO buffer 2 582. The Xᵢₙᵥ FIFO buffer 2 stores Xᵢₙᵥ samples for second non-linear impulse response calculation.

A linear update rule block 585 receives Xᵢₙᵥ from the Xᵢₙᵥ FIFO buffer H 572 and y(n) from the Y memory register 570. The linear update rule block 585 implements the recursive update rule for the linear channel. The output H_{new} from the linear update rule block 585 is provided to a linear impulse response block 587. The linear impulse response block 587 stores linear impulse response coefficients H(0), H(1), H(2), through H(L_{H}−1). The linear impulse response block 587 provides H_{old} back to the linear update rule block 585 for the next iteration.

A first non-linear update rule block 590 receives Xᵢₙᵥ from the Xᵢₙᵥ FIFO buffer 1 577 and y(n) from the Y memory register 575. The first non-linear update rule block 590 implements the recursive update rule for the first non-linear channel. The output H_{new} from the first non-linear update rule block 590 is provided to a first non-linear impulse response block 592. The first non-linear impulse response block 592 stores the first non-linear impulse response coefficients H(0), H(1), through H(L_{HD1}−1), corresponding to the second-order distortion component. The first non-linear impulse response block 592 provides H_{old} back to the first non-linear update rule block 590 for the next iteration.

A second non-linear update rule block 595 receives Xᵢₙᵥ from the Xᵢₙᵥ FIFO buffer 2 582 and y(n) from the Y memory register 580. The second non-linear update rule block 595 implements the recursive update rule for the second non-linear channel. The output H_{new} from the second non-linear update rule block 595 is provided to a second non-linear impulse response block 597. The second non-linear impulse response block 597 stores second non-linear impulse response coefficients H(0), H(1), through H(L_{HD2}−1), corresponding to the third-order distortion component. The second non-linear impulse response block 597 provides H_{old} back to the second non-linear update rule block 595 for the next iteration.

The alternative single-channel measurement system 500 reduces memory usage by replicating signal generation elements for each Xᵢₙᵥ FIFO buffer rather than introducing delay elements on the measured response signal. This architecture is more memory-efficient than delay-based architectures when the condition D2>L_{HD1}+L_{HD2} is satisfied. In delay-based architectures, such as the single-channel measurement system 400 shown in FIG. 4, the measured response signal is delayed by D1 samples to calculate the first non-linear impulse response and by an additional (D2−D1) samples to calculate the second non-linear impulse response, resulting in a total of D2 stored samples for delay memory. In contrast, the alternative single-channel measurement system 500 eliminates delay storage and instead stores only the samples required for impulse response computation. The Xᵢₙᵥ FIFO buffer H 572 stores L_{H} samples, the Xᵢₙᵥ FIFO buffer 1 577 stores L_{HD1} samples, and the Xᵢₙᵥ FIFO buffer 2 582 stores L_{HD2} samples. When D2 exceeds the sum L_{HD1}+L_{HD2}, the total memory for FIFO buffers (L_{H}+L_{HD1}+L_{HD2}) is less than the memory required by a configuration that combines delay elements with shared FIFO storage.

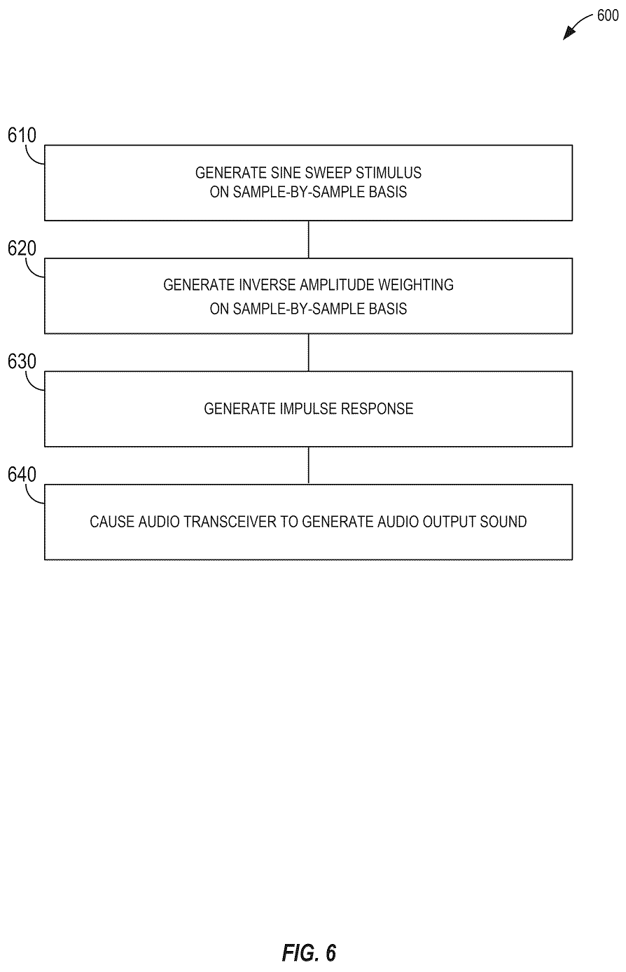

FIG. 6 is a method 600 for performing acoustic characterization using sine sweep measurements on a digital signal processor, in accordance with at least one embodiment of the invention. Method 600 includes generating 610 a sine sweep stimulus on a sample-by-sample basis. Generating the sine sweep stimulus may include recursively calculating each sample without storing an entire stimulus vector. Recursively calculating each sample may include generating an updated frequency parameter for each sample, generating a sine function argument based on the updated frequency parameter, and generating each sample of the sine sweep stimulus based on the sine function argument.

Method 600 may be implemented on a system for performing electroacoustic characterization using sine sweep measurements. The system may include at least one audio transceiver (e.g., audio speaker) configured to reproduce an audio signal, at least one microphone configured to generate a measured response signal, and at least one digital signal processor operably connected to the audio transceiver and to the microphone.

Method 600 includes generating 620 an inverse amplitude weighting on a sample-by-sample basis. Method 600 includes generating 630 an impulse response based on a correlation-based deconvolution based on the measured response signal, the sine sweep stimulus, and the inverse amplitude weighting. The impulse response may characterize a transfer function that includes the audio transceiver (e.g., audio speaker), the microphone, and an acoustic path between the audio transceiver and the microphone. Performing correlation-based deconvolution may include generating an inverse stimulus simultaneously with the sine sweep stimulus and calculating a correlation between the inverse stimulus and the measured response signal. Method 600 may include causing 640 the audio transceiver to generate an audio output sound based on the impulse response.

Method 600 may further include using a circular or first-in-first-out (FIFO) buffer for storing and updating samples of the inverse stimulus. Method 600 may further include recursively updating the impulse response for each new sample of the measured response signal. Recursively updating the impulse response may include multiplying a current sample of the inverse stimulus with a current sample of the measured response signal to generate a correlation product, updating the impulse response by adding the correlation product to a previous impulse response value.

Method 600 may further include generating a plurality of sine waves based on pre-existing lookup tables. Method 600 may further include improving an accuracy of generating the plurality of sine waves based on interpolation methods.

Method 600 may further include processing multi-channel measurements for a plurality of audio channels based on a common use of the inverse stimulus for each of the plurality of audio channels. Method 600 may further include allowing flexible setting of measurement parameters including start frequency, end frequency, and stimulus length. The digital signal processor may include a low-power, memory-constrained processor in a hearing aid device.

Method 600 may further include calculating nonlinear components of the impulse response by introducing a delay in the measured response signal. Method 600 may enable on-device diagnostics, remote fitting, or adaptive calibration of an audio device.

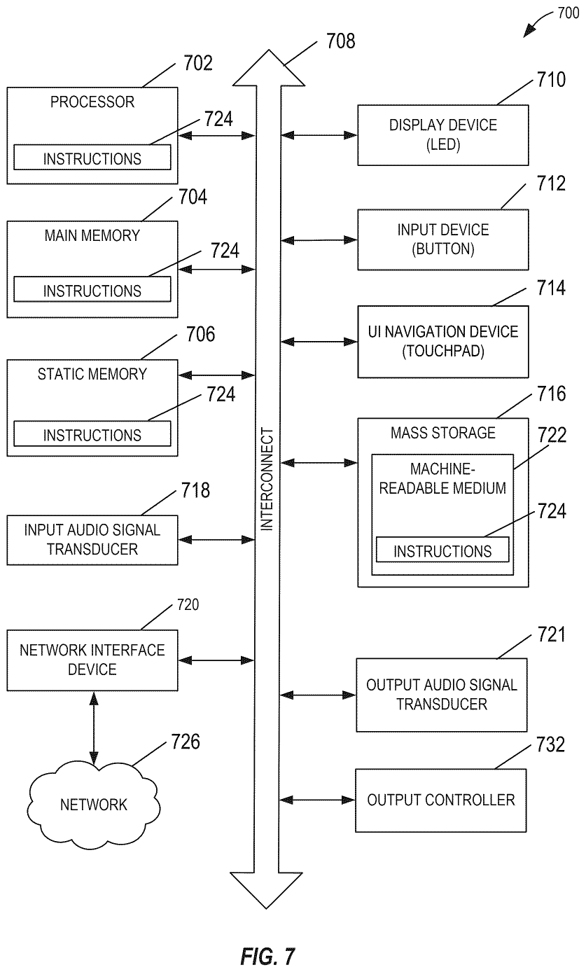

FIG. 7 illustrates a block diagram of an example machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, one or more input audio signal transducers 718 (e.g., microphone), a network interface device 720, and one or more output audio signal transducer 721 (e.g., speaker). The machine 700 may include an output controller 732, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium includes a machine-readable medium with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE [symbol] family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to communicate wirelessly using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700, and includes digital or analog communications signals or other intangible medium to facilitate communication of such software.

Various embodiments of the present subject matter may include a hearing assistance device. Hearing assistance devices typically include at least one enclosure or housing, a microphone, hearing assistance device electronics including processing electronics, and a speaker or “receiver.” Hearing assistance devices may include a power source, such as a battery. In various embodiments, the battery may be rechargeable. In various embodiments multiple energy sources may be employed. In various embodiments, detection and reduction or elimination of feedback includes at least one input transducer and at least one output transducer. These input and output transducers may generate feedback when they are within the same domain, such as a pair of acoustic transceivers, a pair of magnetic transceivers, or other types of input and output transducers within the same domain. It is understood that variations in communications protocols, antenna configurations, and combinations of components may be employed without departing from the scope of the present subject matter. Antenna configurations may vary and may be included within an enclosure for the electronics or be external to an enclosure for the electronics. Thus, the examples set forth herein are intended to be demonstrative and not a limiting or exhaustive depiction of variations.

It is understood that digital hearing aids include a processor. In digital hearing aids with a processor, programmable gains may be employed to adjust the hearing aid output to a particular hearing impairment of a user. The processor may be a digital signal processor (DSP), microprocessor, microcontroller, other digital logic, or combinations thereof. The processing may be done by a single processor, or may be distributed over different devices. The processing of signals referenced in this application may be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples, drawings may omit certain blocks that perform frequency synthesis, frequency analysis, analog-to-digital conversion, digital-to-analog conversion, amplification, buffering, and certain types of filtering and processing. In various embodiments the processor is adapted to perform instructions stored in one or more memories, which may or may not be explicitly shown. Diverse types of memory may be used, including volatile and nonvolatile forms of memory. In various embodiments, the processor or other processing devices execute instructions to perform a number of signal processing tasks. Such embodiments may include analog components in communication with the processor to perform signal processing tasks, such as sound reception by a microphone, or playing of sound using a receiver (i.e., in applications where such transducers are used). In various embodiments, different realizations of the block diagrams, circuits, and processes set forth herein may be created by one of skill in the art without departing from the scope of the present subject matter.

Various embodiments of the present subject matter support wireless communications with a hearing assistance device. In various embodiments, the wireless communications can include standard or nonstandard communications. Some examples of standard wireless communications include, but not limited to, Bluetooth™, low energy Bluetooth, IEEE 802.11 (wireless LANs), 802.15 (WPANs), and 802.16 (WiMAX). Cellular communications may include, but not limited to, CDMA, GSM, ZigBee, and ultra-wideband (UWB) technologies. In various embodiments, the communications are radio frequency communications. In various embodiments, the communications are optical communications, such as infrared communications. In various embodiments, the communications are inductive communications. In various embodiments, the communications are ultrasonic communications. Although embodiments of the present system may be demonstrated as radio communication systems, it is possible that other forms of wireless communications may be used. It is understood that past and present standards may be used. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, ATM, Fiber-channel, Firewire or 1394, InfiniBand, or a native streaming interface. In various embodiments, such connections include all past and present link protocols. It is also contemplated that future versions of these protocols and new protocols may be employed without departing from the scope of the present subject matter.

In various embodiments, the present subject matter is used in hearing assistance devices that are configured to communicate with mobile phones. In such embodiments, the hearing assistance device may be operable to perform one or more of the following: answer incoming calls, hang up on calls, and/or provide two-way telephone communications. In various embodiments, the present subject matter is used in hearing assistance devices configured to communicate with packet-based devices. In various embodiments, the present subject matter includes hearing assistance devices configured to communicate with streaming audio devices. In various embodiments, the present subject matter includes hearing assistance devices configured to communicate with Wi-Fi devices. In various embodiments, the present subject matter includes hearing assistance devices capable of being controlled by remote control devices.

It is further understood that different hearing assistance devices may embody the present subject matter without departing from the scope of the present disclosure. The devices depicted in the figures are intended to demonstrate the subject matter, but not necessarily in a limited, exhaustive, or exclusive sense. It is also understood that the present subject matter may be used with a device designed for use in the right ear or the left ear or both ears of the wearer. The present subject matter may be employed in hearing assistance devices, such as headsets, hearing aids, headphones, and similar hearing devices. The present subject matter may be employed in hearing assistance devices having additional sensors. Such sensors include, but are not limited to, magnetic field sensors, telecoils, temperature sensors, accelerometers, and proximity sensors. The present subject matter may be employed in amplification systems other than hearing assistance devices, such as sound reinforcement systems, telephony, and other acoustic amplification and reproduction systems.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard fitted, open fitted and/or occlusive fitted. It is understood that other hearing assistance devices not expressly stated herein may be used in conjunction with the present subject matter.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Example 1 is a system for performing electroacoustic characterization using sine sweep measurements, the system comprising: at least one audio transceiver configured to reproduce an audio signal; at least one microphone configured to generate a measured response signal; and at least one digital signal processor operably connected to at least one audio transceiver and to the at least one microphone, the at least one digital signal processor configured to: generate a sine sweep stimulus on a sample-by-sample basis; generate an inverse amplitude weighting on a sample-by-sample basis; generate an impulse response based on a correlation-based deconvolution based on the measured response signal, the sine sweep stimulus, and the inverse amplitude weighting; and cause at least one audio transceiver to generate an audio output sound based on the sine sweep stimulus.

In Example 2, the subject matter of Example 1 includes wherein the sine sweep stimulus characterizes a transfer function that includes at least one audio transceiver, the at least one microphone, and an acoustic path between at least one audio transceiver and the at least one microphone.

In Example 3, the subject matter of Examples 1-2 includes the at least one digital signal processor further configured to recursively calculate each sample of the sine sweep stimulus without storing an entire stimulus vector.

In Example 4, the subject matter of Example 3 includes the at least one digital signal processor further configured to recursively calculate each sample of the sine sweep stimulus by: generating an updated frequency parameter for each sample; generating a sine function argument based on the updated frequency parameter; and generating each sample of the sine sweep stimulus based on the sine function argument.

In Example 5, the subject matter of Examples 1~4 includes the at least one digital signal processor further configured to perform correlation-based deconvolution by: generating an inverse stimulus simultaneously with the sine sweep stimulus; and calculating a correlation between the inverse stimulus and the measured response signal.

In Example 6, the subject matter of Example 5 includes wherein the at least one digital signal processor includes a circular or first-in-first-out (FIFO) buffer for storing and updating samples of the inverse stimulus.

In Example 7, the subject matter of Examples 5-6 includes the at least one digital signal processor further configured to recursively update the sine sweep stimulus for each new sample of the measured response signal.

In Example 8, the subject matter of Example 7 includes the at least one digital signal processor further configured to recursively update the sine sweep stimulus by: multiplying one-by-one the samples of the inverse stimulus stored in a memory buffer with a current sample of the measured response signal to generate a correlation product; and updating the estimated impulse response by adding the correlation product to a previous impulse response value.

In Example 9, the subject matter of Examples 1-8 includes the at least one digital signal processor further configured to generate a plurality of sine waves based on pre-existing lookup tables.

In Example 10, the subject matter of Example 9 includes the at least one digital signal processor further configured to improve an accuracy of generating the plurality of sine waves based on interpolation methods.

In Example 11, the subject matter of Examples 5-10 includes the at least one digital signal processor further configured to process multi-channel measurements for a plurality of audio channels based on a common use of the inverse stimulus for each of the plurality of audio channels.

In Example 12, the subject matter of Examples 1-11 includes the at least one digital signal processor further configured to allow flexible setting of measurement parameters including start frequency, end frequency, and stimulus length.

In Example 13, the subject matter of Examples 1-12 includes wherein the system is integrated into a hearing aid device.

In Example 14, the subject matter of Examples 1-13 includes wherein the at least one digital signal processor includes a low-power and memory-constrained processor.

In Example 15, the subject matter of Examples 1-14 includes wherein the sine sweep stimulus on the sample-by-sample basis is generated in real-time without storing an entire measured signal.

In Example 16, the subject matter of Examples 1-15 includes the at least one digital signal processor further configured to calculate non-linear components of the sine sweep stimulus by introducing a delay in the measured response signal.

In Example 17, the subject matter of Examples 1-16 includes wherein the system is configured to enable on-device diagnostics, remote fitting, or adaptive calibration of an audio device.

In Example 18, the subject matter of Examples 16-17 includes the at least one digital signal processor further configured to calculate non-linear components of the impulse response by: generating a plurality of parallel signal generation paths, each signal generation path including a sine sampler and an inverse amplitude block; generating, by each signal generation path, a time-shifted inverse stimulus corresponding to a respective distortion order; and storing, by a respective first-in-first-out (FIFO) buffer for each signal generation path, samples of the time-shifted inverse stimulus for calculating a respective non-linear impulse response.

In Example 19, the subject matter of Example 18 includes wherein the at least one digital signal processor is configured to select between a first architecture that applies delay elements to the measured response signal and a second architecture that uses the plurality of parallel signal generation paths, based on a condition that a delay value for a highest-order distortion component exceeds a sum of lengths of the non-linear impulse responses being measured.

In Example 20, the subject matter of Examples 1-19 includes the at least one digital signal processor further configured to: perform a plurality of impulse response measurements using interleaved and overlapped sine sweep stimuli; average the plurality of impulse response measurements to generate an averaged impulse response having an improved signal-to-noise ratio; and terminate the plurality of impulse response measurements based on at least one of achieving a signal-to-noise ratio threshold or reaching a preset maximum measurement duration.

In Example 21, the subject matter of Examples 1-20 includes wherein the system includes a plurality of audio transceivers, and the at least one digital signal processor is further configured to: estimate a parameter characterizing a ratio between linear and non-linear impulse response energy for each of the plurality of audio transceivers; generate a plurality of delayed sine sweep stimuli for the plurality of audio transceivers based on the estimated parameter; deconvolve measured response signals from the plurality of audio transceivers to generate a combined impulse response; and extract individual impulse responses for each of the plurality of audio transceivers from the combined impulse response based on calculated starting and ending indices.

Example 22 is a method for performing electroacoustic characterization using sine sweep measurements on at least one digital signal processor, the method comprising: generating a sine sweep stimulus on a sample-by-sample basis; generating an inverse amplitude weighting on a sample-by-sample basis; generating an impulse response based on a correlation-based deconvolution based on the measured response signal, the sine sweep stimulus, and the inverse amplitude weighting; and causing at least one audio transceiver to generate an audio output sound based on the sine sweep stimulus.

In Example 23, the subject matter of Example 22 includes wherein the sine sweep stimulus characterizes a transfer function that includes at least one audio transceiver, at least one microphone, and an acoustic path between at least one audio transceiver and the at least one microphone.

In Example 24, the subject matter of Examples 22-23 includes wherein generating the sine sweep stimulus includes recursively calculating each sample of the sine sweep stimulus without storing an entire stimulus vector.

In Example 25, the subject matter of Example 24 includes wherein recursively calculating each sample includes: generating an updated frequency parameter for each sample; generating a sine function argument based on the updated frequency parameter; and generating each sample of the sine sweep stimulus based on the sine function argument.

In Example 26, the subject matter of Examples 22-25 includes wherein performing correlation-based deconvolution includes: generating an inverse stimulus simultaneously with the sine sweep stimulus; and calculating a correlation between the inverse stimulus and the measured response signal.

In Example 27, the subject matter of Example 26 includes using a circular or first-in-first-out (FIFO) buffer for storing and updating samples of the inverse stimulus.

In Example 28, the subject matter of Examples 26-27 includes recursively updating the sine sweep stimulus for each new sample of the measured response signal.

In Example 29, the subject matter of Example 28 includes wherein recursively updating the sine sweep stimulus includes: multiplying one-by-one the samples of the inverse stimulus stored in a memory buffer with a current sample of the measured response signal to generate a correlation product; and updating the estimated impulse response by adding the correlation product to a previous impulse response value.

In Example 30, the subject matter of Examples 22-29 includes generating a plurality of sine waves based on pre-existing lookup tables.

In Example 31, the subject matter of Example 30 includes improving an accuracy of generating the plurality of sine waves based on interpolation methods.

In Example 32, the subject matter of Examples 26-31 includes processing multi-channel measurements for a plurality of audio channels based on a common use of the inverse stimulus for each of the plurality of audio channel.

In Example 33, the subject matter of Examples 22-32 includes allowing flexible setting of measurement parameters including start frequency, end frequency, and stimulus length.

In Example 34, the subject matter of Examples 22-33 includes wherein the at least one digital signal processor is integrated into a hearing aid device.

In Example 35, the subject matter of Examples 22-34 includes wherein the at least one digital signal processor includes a low-power and memory-constrained processor.

In Example 36, the subject matter of Examples 22-35 includes wherein the sine sweep stimulus on the sample-by-sample basis is generated in real-time without storing an entire measured signal.

In Example 37, the subject matter of Examples 22-36 includes calculating non-linear components of the sine sweep stimulus by introducing a delay in the measured response signal.

In Example 38, the subject matter of Examples 22-37 includes wherein the method enables on-device diagnostics, remote fitting, or adaptive calibration of an audio device.

In Example 39, the subject matter of Examples 37-38 includes wherein calculating non-linear components of the impulse response includes: generating a plurality of parallel signal generation paths, each signal generation path including a sine sampler and an inverse amplitude block; generating, by each signal generation path, a time-shifted inverse stimulus corresponding to a respective distortion order; and storing, by a respective first-in-first-out (FIFO) buffer for each signal generation path, samples of the time-shifted inverse stimulus for calculating a respective non-linear impulse response.

In Example 40, the subject matter of Example 39 includes selecting between a first architecture that applies delay elements to the measured response signal and a second architecture that uses the plurality of parallel signal generation paths, based on a condition that a delay value for a highest-order distortion component exceeds a sum of lengths of the non-linear impulse responses being measured.

In Example 41, the subject matter of Examples 22-40 includes performing a plurality of impulse response measurements using interleaved and overlapped sine sweep stimuli; averaging the plurality of impulse response measurements to generate an averaged impulse response having an improved signal-to-noise ratio; and terminating the plurality of impulse response measurements based on at least one of achieving a signal-to-noise ratio threshold or reaching a preset maximum measurement duration.

In Example 42, the subject matter of Examples 22-41 includes wherein the at least one audio transceiver includes a plurality of audio transceivers, and the method further comprises: estimating a parameter characterizing a ratio between linear and non-linear impulse response energy for each of the plurality of audio transceivers; generating a plurality of delayed sine sweep stimuli for the plurality of audio transceivers based on the estimated parameter; deconvolving measured response signals from the plurality of audio transceivers to generate a combined impulse response; and extracting individual impulse responses for each of the plurality of audio transceivers from the combined impulse response based on calculated starting and ending indices.

Example 43 is at least one machine-readable medium including instructions that, when executed by processing circuitry, cause the processing circuitry to perform operations to implement of any of Examples 1-42.

Example 44 is an apparatus comprising means to implement of any of Examples 1-42.

Example 45 is a system to implement of any of Examples 1-42.

Example 46 is a method to implement of any of Examples 1-42.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within the scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

What is claimed is:

1. A system for performing electroacoustic characterization using sine sweep measurements, the system comprising:
at least one audio transceiver configured to reproduce an audio signal;
at least one microphone configured to generate a measured response signal; and
at least one digital signal processor operably connected to at least one audio transceiver and to the at least one microphone, the at least one digital signal processor configured to:
generate a sine sweep stimulus on a sample-by-sample basis;
generate an inverse amplitude weighting on a sample-by-sample basis;
generate an impulse response based on a correlation-based deconvolution based on the measured response signal, the sine sweep stimulus, and the inverse amplitude weighting; and
cause at least one audio transceiver to generate an audio output sound based on the sine sweep stimulus.

2. The system of claim 1, the at least one digital signal processor further configured to recursively calculate each sample of the sine sweep stimulus without storing an entire stimulus vector by:
generating an updated frequency parameter for each sample;
generating a sine function argument based on the updated frequency parameter; and
generating each sample of the sine sweep stimulus based on the sine function argument.

3. The system of claim 1, the at least one digital signal processor further configured to perform correlation-based deconvolution by:
generating an inverse stimulus simultaneously with the sine sweep stimulus; and
calculating a correlation between the inverse stimulus and the measured response signal.

4. The system of claim 3, wherein the at least one digital signal processor includes a first-in-first-out (FIFO) buffer for storing and updating samples of the inverse stimulus, and wherein the at least one digital signal processor is further configured to recursively update the impulse response by:
multiplying samples of the inverse stimulus stored in the FIFO buffer with a current sample of the measured response signal to generate a correlation product; and
updating the impulse response by adding the correlation product to a previous impulse response value.

5. The system of claim 3, the at least one digital signal processor further configured to process multi-channel measurements for a plurality of audio channels based on a common use of the inverse stimulus for each of the plurality of audio channels.

6. The system of claim 1, the at least one digital signal processor further configured to calculate non-linear components of the impulse response by:
generating a plurality of parallel signal generation paths, each signal generation path including a sine sampler and an inverse amplitude block;
generating, by each signal generation path, a time-shifted inverse stimulus corresponding to a respective distortion order; and
storing, by a respective first-in-first-out (FIFO) buffer for each signal generation path, samples of the time-shifted inverse stimulus for calculating a respective non-linear impulse response.

7. The system of claim 6, wherein the at least one digital signal processor is configured to select, based on a condition that a delay value for a highest-order distortion component exceeds a sum of lengths of a plurality of non-linear impulse responses being measured, between a first architecture that applies delay elements to the measured response signal and a second architecture that uses the plurality of parallel signal generation paths.

8. The system of claim 1, the at least one digital signal processor further configured to:
perform a plurality of impulse response measurements using interleaved and overlapped sine sweep stimuli;
average the plurality of impulse response measurements to generate an averaged impulse response having an improved signal-to-noise ratio; and
terminate the plurality of impulse response measurements based on at least one of achieving a signal-to-noise ratio threshold or reaching a preset maximum measurement duration.

9. The system of claim 1, wherein the system includes a plurality of audio transceivers, and the at least one digital signal processor is further configured to:
estimate a parameter characterizing a ratio between linear and non-linear impulse response energy for each of the plurality of audio transceivers;
generate a plurality of delayed sine sweep stimuli for the plurality of audio transceivers based on the estimated parameter;
deconvolve measured response signals from the plurality of audio transceivers to generate a combined impulse response; and
extract individual impulse responses for each of the plurality of audio transceivers from the combined impulse response based on calculated starting and ending indices.

10. A method for performing electroacoustic characterization using sine sweep measurements on at least one digital signal processor, the method comprising:
generating a sine sweep stimulus on a sample-by-sample basis;
generating an inverse amplitude weighting on a sample-by-sample basis;
generating an impulse response based on a correlation-based deconvolution based on a measured response signal, the sine sweep stimulus, and the inverse amplitude weighting; and
causing at least one audio transceiver to generate an audio output sound based on the sine sweep stimulus.

11. The method of claim 10, wherein generating the sine sweep stimulus includes recursively calculating each sample of the sine sweep stimulus without storing an entire stimulus vector by:
generating an updated frequency parameter for each sample;
generating a sine function argument based on the updated frequency parameter; and
generating each sample of the sine sweep stimulus based on the sine function argument.

12. The method of claim 10, wherein performing correlation-based deconvolution includes:
generating an inverse stimulus simultaneously with the sine sweep stimulus; and
calculating a correlation between the inverse stimulus and the measured response signal.

13. The method of claim 12, further including:
storing and updating samples of the inverse stimulus using a first-in-first-out (FIFO) buffer; and
recursively updating the impulse response by multiplying samples of the inverse stimulus stored in the FIFO buffer with a current sample of the measured response signal to generate a correlation product and adding the correlation product to a previous impulse response value.

14. The method of claim 10, further including calculating non-linear components of the impulse response by:
generating a plurality of parallel signal generation paths, each signal generation path including a sine sampler and an inverse amplitude block;
generating, by each signal generation path, a time-shifted inverse stimulus corresponding to a respective distortion order; and
storing, by a respective first-in-first-out (FIFO) buffer for each signal generation path, samples of the time-shifted inverse stimulus for calculating a respective non-linear impulse response.

15. The method of claim 14, further including selecting, based on a condition that a delay value for a highest-order distortion component exceeds a sum of lengths of the non-linear impulse responses being measured, between a first architecture that applies delay elements to the measured response signal and a second architecture that uses the plurality of parallel signal generation paths.

16. The method of claim 10, further comprising:
performing a plurality of impulse response measurements using interleaved and overlapped sine sweep stimuli;
averaging the plurality of impulse response measurements to generate an averaged impulse response having an improved signal-to-noise ratio; and
terminating the plurality of impulse response measurements based on at least one of achieving a signal-to-noise ratio threshold or reaching a preset maximum measurement duration.

17. The method of claim 10, wherein the at least one audio transceiver includes a plurality of audio transceivers, and the method further comprises:
estimating a parameter characterizing a ratio between linear and non-linear impulse response energy for each of the plurality of audio transceivers;
generating a plurality of delayed sine sweep stimuli for the plurality of audio transceivers based on the estimated parameter;
deconvolving measured response signals from the plurality of audio transceivers to generate a combined impulse response; and
extracting individual impulse responses for each of the plurality of audio transceivers from the combined impulse response based on calculated starting and ending indices.

18. A non-transitory computer-readable medium storing instructions that, when executed by at least one digital signal processor, cause the at least one digital signal processor to perform operations comprising:
generating a sine sweep stimulus on a sample-by-sample basis;
generating an inverse amplitude weighting on a sample-by-sample basis;
generating an impulse response based on a correlation-based deconvolution based on a measured response signal, the sine sweep stimulus, and the inverse amplitude weighting; and
causing at least one audio transceiver to generate an audio output sound based on the sine sweep stimulus.

19. The non-transitory computer-readable medium of claim 18, wherein the operations further comprise:
generating an inverse stimulus simultaneously with the sine sweep stimulus;
storing samples of the inverse stimulus in a first-in-first-out (FIFO) buffer;
calculating a correlation between the inverse stimulus and the measured response signal; and
recursively updating the impulse response by multiplying samples of the inverse stimulus stored in the FIFO buffer with a current sample of the measured response signal and adding a resulting correlation product to a previous impulse response value.

20. The non-transitory computer-readable medium of claim 18, wherein the operations further comprise:
performing a plurality of impulse response measurements using interleaved and overlapped sine sweep stimuli;
averaging the plurality of impulse response measurements to generate an averaged impulse response having an improved signal-to-noise ratio; and
terminating the plurality of impulse response measurements based on at least one of achieving a signal-to-noise ratio threshold or reaching a preset maximum measurement duration.
